(19) United States
(12) Patent Application Publication
(10) Pub. No.: US 2012/0229598 A1
(43) Pub. Date: Sep. 13, 2012

(54) Method of Transmitting Holograms Electronically and Storing 3D Image in a Hologram and Restoring and Reproducing the 3D Image for Viewing

(76) Inventors: Roger R.Y. Ford, Beverly Hills, CA (US); Yuri Valentine Rostovtsev, Denton, TX (US)

(21) Appl. No.: 13/413,932

(22) Filed: Mar. 7, 2012

Related U.S. Application Data
(60) Provisional application No. 61/450,348, filed on Mar. 8, 2011.

(51) Int. Cl. H04N 13/02; H04N 5/335

(52) U.S. Cl. 348/40; 348/E05.091; 348/E13.074

(57) ABSTRACT

A high frequency modulated laser beam is used to illuminate an object and a suitable detector and/or CCD camera is used to record or photograph the interference pattern with proper optical resolution to produce a hologram that can store 3M image. The recorded or photographed image or interference pattern produced by the laser beam is then exposed to a reconstruction laser beam that is a high frequency modulated beam to restore the hologram and reproduce or transfer the image so that it can be viewed in full 3M on a suitable device such as a television or motion picture screen.

### CROSS-REFERENCES TO RELATED APPLICATIONS

This application claims the priority of provisional Patent Application No. 61/450,348 filed on Mar. 8, 2011.

### BACKGROUND OF THE INVENTION

1. Field of the Invention

The present invention relates to a method for transmitting holograms electronically for three-dimensional (“3D”) viewing of images, and, more particularly, to such a method that does not require the use of special glasses or viewing devices for 3D viewing.

2. Description of the Background Art

There are currently many different types of 3D viewing systems in use for television, motion pictures and the like, all of which require the use of special glasses for 3D viewing. These systems are subject to one or more of the following disadvantages:

1. They do not show natural 3D and require special glasses, viewing devices or equipment;

2. There may be deleterious effects on the brain or the eyes by continuous long term viewing with special 3D glasses;

3. There may be a degradation of clarity, color or sound;

4. Significant changes are required to TV broadcasting systems;

5. 3D systems for television and motion pictures are complicated and expensive; and

6. The quality of the 3D viewing may vary depending on the viewing angles and distances from the TV or motion picture screen.

Accordingly, a need has arisen for a new and improved 3D viewing method which does not require the use of special glasses or viewing devices for 3D viewing. The present invention meets this need.

### BRIEF SUMMARY OF THE INVENTION

In the present invention, a high frequency modulated laser beam is used to illuminate an object and a suitable detector and/or CCD camera is used to record or photograph the interference pattern with proper optical resolution to produce a hologram that can store 3D image. The recorded or photographed image or interference pattern produced by the laser beam is then exposed to a reconstruction laser beam that is a high frequency modulated beam to restore the hologram and reproduce or transfer the image so that it can be viewed in full 3D on a suitable device such as a television or motion picture screen.

### BRIEF DESCRIPTION OF THE DRAWINGS

FIG. 1 is a schematic view of a method of writing a hologram in accordance with the present invention; and

FIG. 2 is a schematic view of a method of reading a hologram in accordance with the present invention.

### DETAILED DESCRIPTION OF THE INVENTION

From electromagnetic theory of radiation, it is known that the field on the boundary of some volume determines the distribution of the field inside the volume. Holograms make use of this theorem in reproducing the image of an object in the volume when the object is removed. Recording the distribution of electromagnetic fields on the boundary allows one to restore the complete image of the fields in the volume at later times.

An object is illuminated with a continuous wave laser, and scattered light from the object falls on the surface where it interferes with the radiation from the laser. The interference pattern is then photographed with proper optical resolution and this “image” is a typical hologram. Then when the developed photograph is shined by a coherent laser radiation, the image is restored and can be seen.

In the present invention, high frequency modulated laser radiation is used to write a hologram. In particular, the modulation frequency can be high so that the wavelength should be small enough, for example it can be 3 millimeters, to provide sufficient details about an image, and there should be technology to perform such modulation. The modulation can be done by an electro-optical modulator of Titanium-doped crystal of LiNbO3 [See J. B. Khurgin, J. U. Kang, and Y. J. Ding, Optics Letters v25, pp 70-72 (2000)].

To detect holograms of three millimeters wavelength, one must meet a number of requirements:

First, the level of coherence of optical light used in the system should be long enough to maintain the coherence during the recording time of one frame, e.g. 3 mm.

Second, the electronics must have enough time resolution to be able to record a hologram with 100 frames a second (e.g., with the use of a standard electronics camera).

The collector does not pick up the diffraction of the light on the atomic level, but smears it out. However, when it is smeared out, the average intensity shows interference on the envelope curves caused by the modulation of the light. The transmitted signals are holograms of three millimeters wavelength.

Let the wavenumbers of the slowly varying terms be k and k′ and the wavenumbers of the quickly varying terms be K and K′,

The light typically can be described by

Cos K×Cos kx

Then, a typical interference term would be

Cos K×cos K′x cos kx cos k′x=[cos(K+K′)+cos(K−K′)][(cos(k+k′)+cos(k−k′)]

It can be seen that there are slowly varying terms that form an envelope curve which determines the interference and diffraction on the hologram.

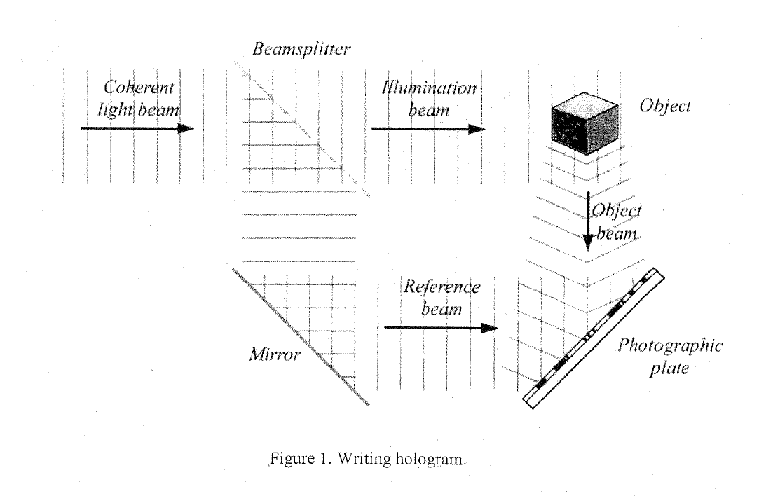

The principle scheme of the device to write a hologram is shown in FIG. 1. The scheme is similar to the ordinary hologram writing with the exceptions that a modulated with high frequency laser beam is used, and instead of a photographic plate, a suitable detector and/or CCD camera is used.

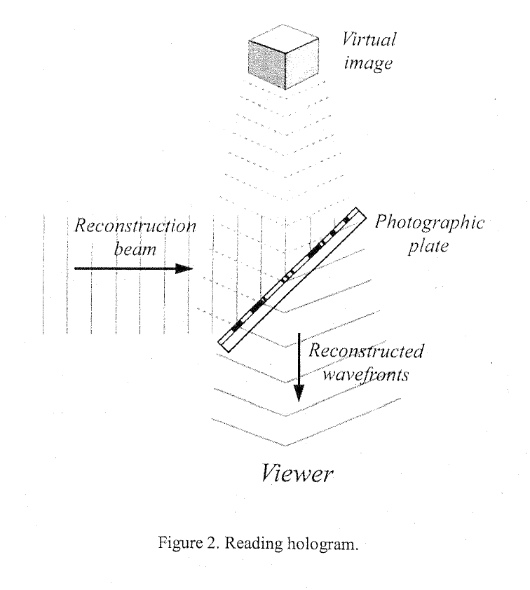

Referring to FIG. 2, due to modulation, the detector can filter modulation frequency and determine both the amplitude and phase at the high frequency at each pixel of the CCD plate. This data then can be transferred from “camera-side” to a “user-side” device where the hologram will be restored, and the image can be seen. The interference pattern produced by the laser beam can be recorded and transferred from studio to user place. Modulation of the laser beam is used to obtain hologram for beating frequency. It allows 3D pictures to be stored in a hologram that can be restored and reproduce image at the other end, where it can be viewed in full 3D.

To enhance the spatial resolution and enhance quality of transmitted images, several low-frequency holograms of the object are registered, and then reconstruction is performed. Each hologram consists of data of an image with some spatial resolution that depends on the modulation frequency. Creating several holograms, with slightly shifted spatial distributions, allows for the collection of more data for the image that can be used in a reconstruction process. Generally, the image is a convolution of the image and spatial apparatus function, which leads to loss resolution of the image. Reconstruction of the image from different positions allow for improved spatial resolution. The hologram is written using optical wavelength, so theoretically the spatial resolution is determined by optical wavelength, i.e. of the order of half a micrometer. Resolution of the image is determined by the wavelength of the modulation frequency, so it is of the order of a millimeter. Performing reconstruction by several times allows resolution to be enhanced by the same number of times. Thus, spatial resolution can be as low as tens of micrometers.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of creating a hologram that can store a 3D image and restoring and reproducing the image so that it can be viewed in full 3D, comprising:
illuminating the image with a high frequency modulated laser beam to produce an interference pattern;
recording or photographing the interference pattern with a detector and/or CCD camera to produce a hologram that stores the image in 3D picture form; and
restoring and reproducing the hologram so that it can be viewed in full 3D on a viewing device.

2. The method of claim 1 wherein the hologram is restored and reproduced by exposing the recorded or photographed interference pattern to a reconstruction laser beam that is a high frequency modulated beam.

3. The method of claim 1 wherein the wavelength of the high frequency modulated laser beam is 3 mm.

4. The method of claim 1 wherein the high frequency laser beam is modulated by an electro-optical modulator of titanium-doped crystal of LiNbO3.

5. The method of claim 1 wherein the detector and/or CCD camera has sufficient time resolution to record a hologram with 100 frames a second.

6. The method of claim 2 wherein the detector filters modulation frequency and determines the amplitude and phase at the high frequency at each pixel of a plate of the CCD camera.

7. The method of claim 1 wherein, to enhance the spatial resolution and quality of transmitted images, a plurality of low frequency holograms of the image are produced and reconstructed, each hologram comprising data of the image with some spatial resolution that depends on the modulation frequency.
